(19) United States
(12) Patent Application Publication
(10) Pub. No.: US 2004/0189483 A1
(43) Pub. Date: Sep. 30, 2004

(54) INSTRUMENT CLUSTER FLOOD LIGHTING UTILIZING ULTRAVIOLET LED

(76) Inventor: Steven A. Stringfellow, Oakland, MI (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/400,170

(22) Filed: Mar. 26, 2003

(51) Int. Cl. G08B 5/00

(52) U.S. Cl. 340/815.4; 362/23

(57) ABSTRACT

An instrument cluster assembly for use in a vehicle, the instrument cluster assembly including a semiconductor for emitting black light, an instrument cluster display, a plurality of graphic features located on the instrument cluster display, the graphic features being illuminable by black light, where the graphic features become illuminated when contacted by the black light the semiconductor.

### TECHNICAL FIELD

The present invention relates to a motor vehicle interior. More specifically, the present invention relates to an instrument cluster assembly for use in a motor vehicle.

### BACKGROUND OF THE INVENTION

It is well known in the prior art to provide an instrument cluster assembly that provides information to the driver regarding speed, fuel level, and an unlimited variety of other information. Depending on the desired design effect, it is commonly known to provide this information in either a traditional analogue form, including gauges having dials with pointers, or alternately in a form having a digital appearance. Most conventional analog instrument cluster displays include gages that are backlit with an array of incandescent bulbs or white LEDs in conjunction with acrylic light pipes that are placed behind the cluster graphics. These bulbs require a certain amount of air for cooling, thus driving a certain space requirement or volume requirement for packaging the incandescent bulbs in the instrument cluster panel. With both incandescent bulbs and white LEDs, it is difficult to completely eliminate bright spots and attain an even illumination of the instrument cluster graphics. These hot spots require careful compensation methods to balance the lighting across the display graphics.

Typically, the pointers used in analogue clusters are constructed as bulky, wedge-shaped, acrylic light pipes which project light along the length of the pointers. Due to the light source being behind the graphic face, a small amount of light can leak beneath the pointer and cause an undesirable glow beneath the pointers. In addition, the pointers are limited by optical physics in their shape and configuration, since they must evenly emit light along their length. The optics dictate the design of wedged straight pointers with relatively wide tips. Light pipes also have the limitation of requiring the graphics to remain on one plane. Evenly transferring light across two or more horizontal graphic plateaus requires additional bulbs and complexity.

Another method of lighting an analogue instrument cluster is front-flooding the instrument cluster with visible light provided by a plurality of incandescent, visible LED, or fluorescent bulbs placed above and/or below the instrument cluster. The front-flooding of the instrument cluster by visible light illuminates the entire cluster, not just the informational features, giving a less attractive appearance than the backlit version.

As vehicle manufacturers progress in vehicle designs, new and innovative looks are desirable for the vehicle interior. In the area of instrumentation, design goals include providing economical instrumentation that is easy to read, less bulky, less heavy, easy to assembly to the vehicle, and more flexible in design. Obtaining some or all of these goals opens the opportunity for more aesthetically pleasing designs of instrument cluster displays.

### SUMMARY OF THE INVENTION

The present invention provides alternatives and advantages over the prior art by providing an instrument cluster assembly that is easy to read, lightweight, less costly, less bulky, and has fewer components and greater design flexibility than instrument cluster assemblies of the prior art. Furthermore, the present invention requires less energy consumption than prior art instrument cluster assemblies.

The present invention provides an instrument cluster assembly that selectively illuminates the graphic features of the instrument cluster display without the illumination of any surrounding portions of the instrument cluster display. Preferably, this is accomplished without the use of visible light, but instead with the use of invisible black light or electromagnetic energy in the ultraviolet (UV) spectrum (electromagnetic energy having wavelengths generally shorter than 3.9×10⁻⁷ meters or 390 nanometers).

The present invention further provides an instrument cluster assembly which requires less packaging space than instrument cluster assemblies of the prior art. Advantageously, the use of black light requires less power, generating less heat than the prior art, allowing for reduced packaging space. The present invention provides an instrument cluster assembly having clear, crisp night time lighting without any substantial shadows or pointer hub glow. The present invention further provides an evenly illuminated instrument cluster display.

A further feature of the present invention provides the opportunity for a multi-dimensional or “holographic” effect on the instrument cluster display at night by the physical placement of instrument gages on multiple planes as enabled by the use of black light sources. Advantageously, the present invention provides the enablement of an unlimited amount of colors, shapes, sizes, and designs of graphic information displays in a cost effective manner. The present invention also provides an instrument cluster assembly that is a compact module for easy assembly as a single unit to the vehicle.

These advantages and alternatives of the present invention are accomplished by providing an instrument cluster assembly for use in a vehicle. The instrument cluster assembly includes a light source for emitting black light and an instrument cluster display including at least one graphic feature that is illuminable by black light. The invisible black light illuminates only the graphic features when contacted by the black light from the light source without illuminating the surrounding portions of the instrument cluster display. Preferably, the light sources are one or more light emitting diodes for emitting ultraviolet light. The assembly may also include at least one reflector and the graphic features are preferably made of a phosphoric material.

According to other aspects of the invention, the light source preferably includes light sources that are positioned opposite the instrument cluster display and laterally spaced apart from and in front of the graphic features. The assembly may also include reflectors positioned adjacent the light sources, respectively, for redirecting black light initially emitted towards the reflectors onto the instrument cluster display. The reflectors may be aspheric, having different curvatures in the horizontal and vertical directions. The instrument cluster display preferably has a three-dimensional effect by having a plurality of graphic features located on at least two or more different planes.

In accordance with other preferred aspects of the invention, the instrument cluster assembly includes a cluster lens covering the instrument cluster display. The cluster lens preferably has an aspheric, cylindrical or elliptical shape and is made of a material having properties that inhibit the transfer of ultraviolet energy through the cluster lens. Due to the high grazing angles, the lens also has the characteristic of reflecting UV. The instrument cluster display preferably includes at least one gage with at least one of the graphic features being a pointer centrally mounted on the gage and extending through the center of the gage as enabled by the use of remote black light sources, rather than light pipes. Furthermore, the instrument cluster display includes at least one gage and an outer bezel surrounding the gage. The bezel is angled inwardly for permitting the black light to contact the center of the gage and eliminate shadows on the gage. Preferably, each of the light sources illuminates more than half of the instrument cluster display for elimination of shadows. Such an instrument cluster assembly is described in U.S. Pat. No. 5,997,161, which is hereby incorporated by reference in its entirety.

### BRIEF DESCRIPTION OF THE DRAWINGS

The present invention will now be described, by way of example, with reference to the accompanying drawings in which:

FIG. 1 is a front view of the instrument cluster assembly in the assembled condition; and

FIG. 2 is a cut away side view of the instrument cluster assembly.

### DESCRIPTION OF THE PREFERRED EMBODIMENT

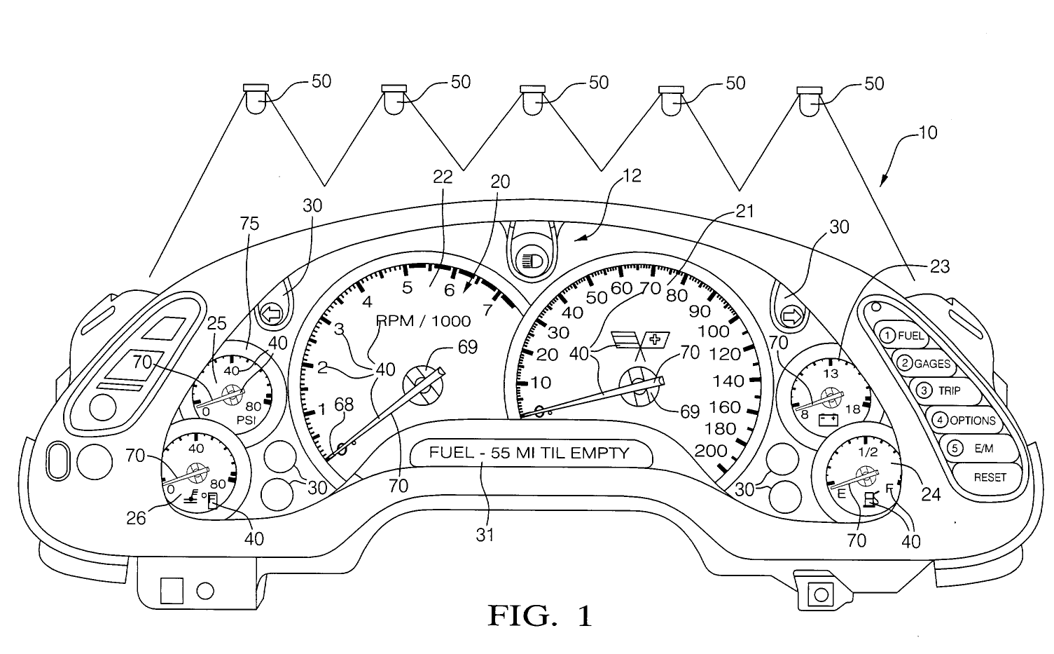

Referring to FIG. 1, an instrument cluster assembly 10 includes the instrument cluster display, generally designated as 20. As best shown in FIG. 1, the instrument cluster display 20 includes a plurality of gages 21, 22, 23, 24, 25, 26 located on a plurality of fore/aft planes. The plurality of gages 21, 22, 23, 24, 25, 26 contain a plurality of graphic features 40, including pointers 70, that are illuminated by the black light sources 50, as described further hereinafter. In addition, the instrument cluster display 20 may also include some traditional informational features, such as numerous backlit telltale lights 30 and a multi-character vacuum fluorescent display information center 31 which are selectively lit for certain conditions.

The first main gage 21 is preferably a speedometer and the second main gage 22 is preferably a tachometer. The first and second main gages 21, 22 are preferably overlapped and seated on different fore/aft planes, as best shown in FIG. 1. The gages 21, 22 are preferably generally centered on the instrument cluster display 20. The first gage 21 is seated on a plane closer to the vehicle driver than the second gage 22.

The display 20 also includes upper and lower right side gages 23, 24 for measuring voltage and fuel level, respectively. The instrument cluster display 20 further includes upper and lower left side gages 25, 26 for measuring engine oil pressure and temperature, respectively. The right and left side gages 23, 24, 25, 26 are preferably smaller than the central main gages 21, 22 and are each angled inwardly towards the center of the instrument cluster display 20 for easy viewing by a vehicle driver and to prevent a parallax effect. Furthermore, the upper gages 23, 25 are located further away from the driver in the fore/aft direction than the lower gages 24, 26. In addition, the right and left side gages 23, 24, 25, 26 are located on fore/aft planes that differ from the fore/aft planes of the central first and second main gages 21, 22. Advantageously, the gages 21, 22, 23, 24, 25, 26 on the instrument cluster display 20 provide a three-dimensional effect when viewed on the multiple planes. At night, the three-dimensional effect becomes holographic as it appears that the gages 21, 22, 23, 24, 25, 26 are floating on different planes. This physical three-dimensional effect is enabled by the use of black light sources 50 of the instrument cluster display 20 which prevent the shadows and glows necessarily present in the prior art. Furthermore, the angling and the multi-planar positioning of the gages 21, 22, 23, 24, 25, 26 is also enabled by the use of black light sources 50, spaced apart from the instrument cluster display 20. In the preferred embodiment of the present invention, the black light sources 50 are light emitting diodes (LEDs) or similar solid state semiconductors that emit photons in substantially the ultraviolet range of the electromagnetic spectrum.

It will be appreciated that the information on the gages 21, 22, 23, 24, 25, 26 is merely exemplary and that any information may be displayed on the various gages. It will further be appreciated that the arrangement and number of gages 21, 22, 23, 24, 25, 26 is also exemplary, although it is preferred that there are multiple gages on multiple planes. It will further be appreciated that the gages need not be dial-type, but may be in any format in which information is to be displayed, including a digital format. It is noted that the forward and rearward directions are determined relative to the instrument cluster assembly 10, such that the instrument cluster display 20 will be referenced as facing forward with the first gage 21 being the furthest forward of the gages, even through the display 20 would be facing rearward relative to the vehicle.

Each of the gages 21, 22, 23, 24, 25, 26 includes a plurality of graphic features 40 including numbers, tick marks, letters and other graphic illustrations, including pointers 70, as desired. The graphic features 40 are preferably made from phosphoric ink or other phosphoric materials which are illuminable by black light. In addition, each gage 21, 22, 23, 24, 25, 26 preferably includes a pointer 70 mounted on a central knob 69 on each of the gages 21, 22, 23, 24, 25, 26. The pointers 70 are preferably made of a molded plastic material which is made of or is coated by a phosphoric substance that is illuminable by black light. Advantageously, the graphic features 40, including the pointers 70, can be of virtually any shape and size outlined by the phosphoric material since. Advantageously, the pointers 70 can extend through the center of the knobs 69. In addition, the pointers 70 can include sharply pointed ends 68 while still being illuminated. In addition, the graphic features 40, including the pointers 70, can be made of virtually any color which is available in the phosphoric material and which also provides good visibility and contrast in daytime lighting. The graphic features 40 shown, including the pointers 70, may be of virtually any configuration and are exemplary only. It will be appreciated that the LED black lighting permits the pointers to even be made in the shape of cars (as an example). Thus, it will be appreciated that the use of phosphoric material illuminated by remotely-located LED black light sources 50 enables a limitless possibility of easily executed design options that were not previously possible.

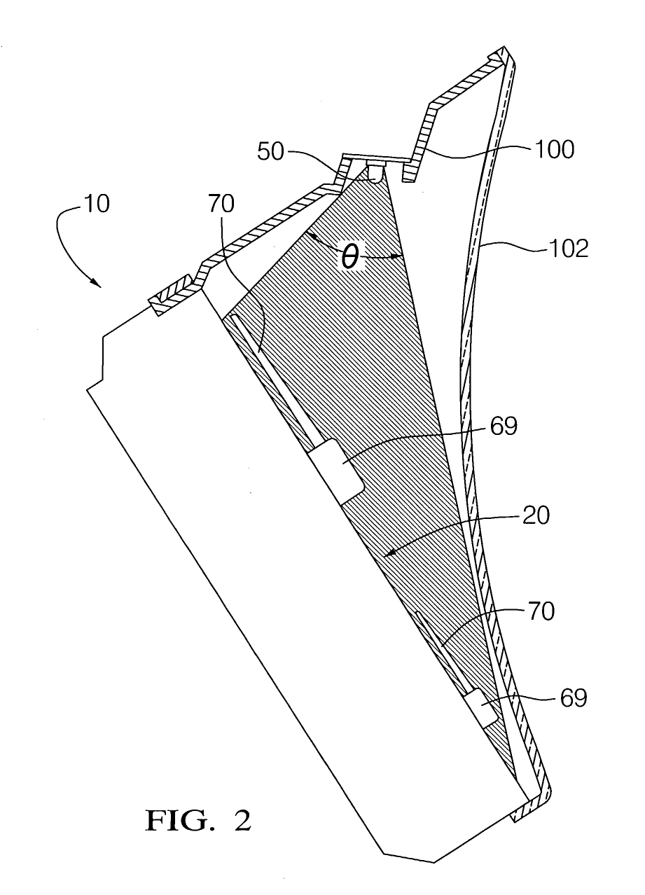

FIG. 2 is a side view of the instrument cluster assembly 10 illustrating the light generated by a black light source 50 comprising an LED. The LED 50 is hidden from view by a mask 100 and positioned to generate a cone of black light, having an angle θ, directed at the instrument cluster 20 so as to illuminate the instrument cluster 20. In a preferred embodiment of the present invention, an array of light emitting diodes 50 are positioned to illuminated the instrument cluster 20. A cluster lens 102 covers the instrument cluster 20 to protect the instrument cluster 20 from damage. The cluster lens 102 preferably has an aspheric, cylindrical or elliptical shape and is made of a material having properties that inhibit the transfer of ultraviolet energy through the cluster lens 102

While this invention has been described in terms of some specific embodiments, it will be appreciated that other forms can readily be adapted by one skilled in the art. Accordingly, the scope of this invention is to be considered limited only by the following claims.

1. An instrument cluster assembly for use in a vehicle, the instrument cluster assembly comprising:
a semiconductor for emitting black light;
an instrument cluster display;
a plurality of graphic features located on said instrument cluster display, said graphic features being illuminable by black light; and
whereby said graphic features become illuminated when contacted by said black light from said semiconductor.

2. The instrument cluster assembly of claim 1, wherein said semiconductor is a light emitting diode.

3. The instrument cluster assembly of claim 1 wherein said graphic features comprise a phosphoric material.

4. The instrument cluster assembly of claim 1 further comprising a plurality of semiconductors for emitting said black light.

5. The instrument cluster assembly of claim 2 wherein said light emitting diode is positioned to direct a cone of light onto said instrument cluster display.

6. The instrument cluster assembly of claim 1 further comprising reflectors for redirecting said black light onto said instrument cluster display.

7. The instrument cluster assembly of claim 1 further comprising a cluster lens covering said instrument cluster display.

8. An instrument cluster assembly for use in a vehicle, the instrument cluster assembly comprising:
a semiconductor for emitting ultraviolet light;
an instrument cluster display; and
a plurality of graphic features located on said instrument cluster display, said graphic features being illuminable by said ultraviolet light;
whereby the graphic features become illuminated when contacted by said ultraviolet light.

9. The instrument cluster assembly of claim 8, wherein said semiconductor is a light emitting diode.

10. The instrument cluster assembly of claim 8, wherein said graphic features are made of a phosphoric material.

11. The instrument cluster assembly of claim 8 further comprising a plurality of semiconductors for emitting said ultraviolet light.

12. The instrument cluster assembly of claim 9, wherein said light emitting diode is positioned to direct a cone of ultraviolet light onto said instrument cluster display.

13. The instrument cluster assembly of claim 8 further comprising reflectors for redirecting said ultraviolet light onto said instrument cluster display.

14. A method for illuminating an instrument cluster display comprising generating ultraviolet light with a semiconductor directed at the instrument cluster display.
